(19) United States
(12) Patent Application Publication
(10) Pub. No.: US 2003/0086262 A1
(43) Pub. Date: May 8, 2003

(54) Decorative lighting string

(76) Inventor: Hung Wen Lee, Chupei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/985,201

(22) Filed: Nov. 2, 2001

(51) Int. Cl. F21V 21/00

(52) U.S. Cl. 362/249; 362/252

(57) ABSTRACT

The present invention relates to a decorative lighting string, which includes several branch string units being connected in series, and each string unit includes several bulbs connected in parallel. When any bulb on the lighting string is broken, it will not affect any other bulb that maintains the lighting string working as usual. And the broken bulb can be found and replaced easily and quickly.

### BACKGROUND OF THE INVENTION

A conventional linear lighting string includes bulbs, which are totally connected with each other in series or otherwise all in parallel. A series connected lighting string can not be normally used when one of the bulbs is broken. A parallel connected lighting string although can overcome the drawback of the series lighting string but it needs high electrical power that will not be economic and is possibly dangerous in use.

Accordingly, the primary object of the invention is to provide a decorative lighting string, which includes several branch string units to be connected for providing a utility and invented decorative lighting string. Now the features and advantages of the present invention will be described in detail with reference to the accompanying drawings.

### BRIEF DESCRIPTION OF ACCOMPANYING DRAWINGS

FIG. 1 is an exemplary plan view showing a decorative lighting string according to the present invention.

### DETAILED DESCRIPTION OF PREFERRED EMBODIMENTS

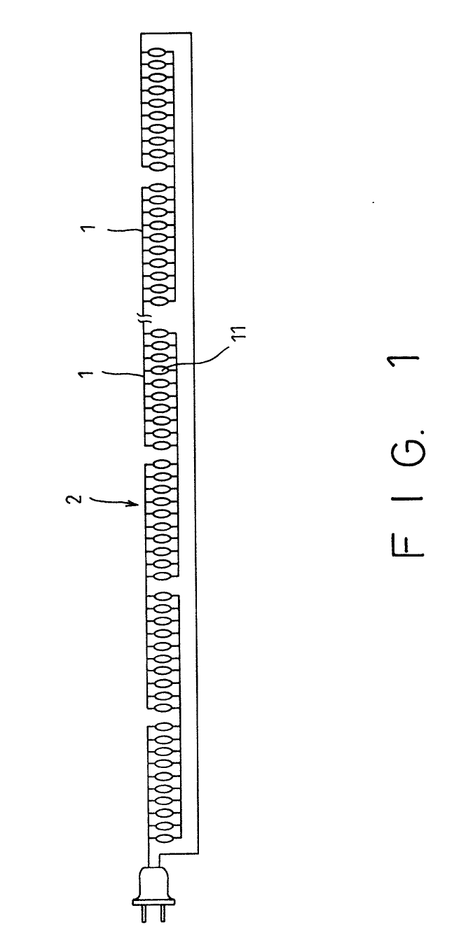

Please refer to FIG. 1, the present invention relates to a decorative lighting string, especially to a linear lighting string (2). The lighting string (2) includes several branch string units (1), each of which has several bulbs (11) being connected together in parallel, in this embodiment is ten bulbs (11) and can be variable. Each string unit (1) is connected in series to form a decorative lighting string in accordance with the present invention. Since every bulb (11) is connected in parallel relating to any other in this invention, it can be found that any bulb (11), if broken, will not affect the others and the lighting string (2) can maintain its original decorating effect as usual. Moreover, the broken bulb (11) can be found easily and replaced quickly. The needed electrical power can be lower because the series connection between each branch string units (1).

In application of the present invention, the branch string unit (1) is variable, such as to connect with different shaped bulbs, to change the angle or direction relating to each other, that increases decorating effect and novelty.

Accordingly, the present invention provides an invented structure with improved utility. It obviously gains the utility and novelty for patent and is thus applied.

What is claimed is:

1. A decorative lighting string including a linear lighting string, which is formed by several branch string units connected in series, and each string unit being provided with several bulbs connected in parallel.

2. The decorative lighting string as claimed in claim 1, wherein the string unit is provided with variable shaped bulbs.

3. The decorative lighting string as claimed in claim 1, wherein each string unit can be connected together having a different relating angle or direction
